(19) United States
(12) Patent Application Publication
(10) Pub. No.: US 2026/0004295 A1
(43) Pub. Date: Jan. 1, 2026

(54) ENHANCED BIOMETRIC MULTIFACTOR AUTHENTICATION FOR TRANSACTIONS

(71) Applicant: NCR Voyix Corporation, Atlanta, GA (US)

(72) Inventors: Gina Torcivia Bennett, Lawrenceville, GA (US); Kip Oliver Morgan, Atlanta, GA (US)

(21) Appl. No.: 18/756,855

(22) Filed: Jun. 27, 2024

(51) Int. Cl. G06Q 20/40; G06Q 20/38; G06V 40/16; G06V 40/20

(52) U.S. Cl. CPC G06Q 20/40145; G06Q 20/3823; G06Q 20/3825; G06Q 20/3827; G06V 40/174; G06V 40/28

(57) ABSTRACT

The present invention relates to an enhanced biometric authentication technique designed for secure retail transactions. A multifactor authentication process is integrated with facial recognition, facial expressions, and hand gestures. When a customer, previously registered with a third-party facial recognition service, is identified at a retail terminal, a loyalty identifier is retrieved, and the transaction begins. For heightened security during payment, the customer is required to perform at least two pre-registered biometric actions-either facial expressions and/or hand gestures-within a predefined time interval. Upon successful authentication, automatic payment is processed on behalf of the user for a transaction. This multiple factor authentication not only bolsters security against fraud but also ensures that the transaction is conducted with the customer's active participation/consent. The system's flexibility allows customers to pre-register their biometric data and set preferences for the authentication sequence and timing, significantly enhancing both security and user experience in retail settings.

### BACKGROUND

In the retail sector, ensuring secure and efficient transaction processes is crucial. Traditional payment methods often lack robust security measures, making them susceptible to fraud. The advent of facial recognition technology has introduced a higher level of security and personalization in customer identification. However, challenges remain, particularly in accurately distinguishing individuals and confirming user consent.

### BRIEF DESCRIPTION OF THE DRAWINGS

FIG. 1A is a diagram of a system for enhanced biometric multifactor authentication for transactions, according to an example embodiment.

FIG. 1B is a diagram of illustrating a data flow associated with the system of FIG. 1A, according to an example embodiment.

FIG. 1C is a pictorial diagram depicting example user interactions for enhanced biometric multifactor authentication during a transaction at a terminal, according to an example embodiment.

FIG. 2 is a flow diagram of a method for enhanced biometric multifactor authentication for a transaction, according to an example embodiment.

FIG. 3 is a flow diagram of another method for enhanced biometric multifactor authentication for a transaction, according to an example embodiment.

### DETAILED DESCRIPTION

In the realm of retail transactions, the security and efficiency of payment processes are paramount. Traditional methods of payment and customer identification, while functional, often fall short in terms of security, particularly in the face of sophisticated fraud techniques and the need for quick transaction times. Recent advancements in biometric technologies, such as facial recognition, have begun to address these concerns by offering more secure and personalized methods of identification. However, these technologies are not without their limitations, particularly in distinguishing between individuals with closely similar appearances and ensuring the consent and awareness of the user during transactions.

Additionally, both stores and consumers have a vested interest in mitigating fraudulent transactions. For stores, a fraudulent transaction typically means covering the loss, as credit card companies often charge back the fraudulent transaction to the store for a refund. For consumers, it means they must detect the fraud within a predefined period after the transaction posts to their account and provide evidence to the credit card company to prove the transaction was fraudulent. This process is time-consuming and a significant hassle for consumers. Since the fraud occurred at a particular store through no fault of their own, the store risks losing customer loyalty and potential business.

Embodiments of invention address these challenges by introducing an enhanced biometric authentication system and methods that utilizes a multifactor authentication process. The system and methods integrate facial recognition with additional biometric modalities, specifically facial expressions and hand gestures, to provide a robust and secure method of user authentication during retail transactions. Upon initiating a transaction at a terminal, a customer's identity is preliminarily verified through a third-party facial recognition and loyalty linking service, which also retrieves a loyalty identifier for the customer. To enhance security, particularly at the critical point of payment, the customer is required to perform at least two pre-registered facial expressions or hand gestures within a predefined time interval. This dual-factor authentication process not only bolsters security but also ensures that the transaction is being conducted with the full awareness and consent of the customer.

The system and methods are designed to be flexible and user-friendly, allowing customers to pre-register their biometric data using their personal devices and to specify preferences such as the sequence and timing of the required gestures. This approach not only enhances security by adding a layer of biometric verification but also improves the overall customer experience by streamlining the transaction process and reducing the risk of fraud. Through this innovative integration of biometric technologies, the embodiments of the invention significantly advance the field of secure retail transactions.

The system and methods enhance consumer and store transaction security without requiring any modifications to the existing software and systems of payment servers and financial institution servers. These systems and methods are fully integrated into the transaction workflow, ensuring they do not impact existing or legacy workflows associated with current payment servers and financial institution servers while providing enhanced fraud protection to the retailers, stores, and consumers not current available in the industry.

As used herein, a “consumer,” “customer,” and/or “user” can be used synonymously and interchangeable. This refers to an individual engaged in a transaction at a transaction terminal and has registered for multifactor authentication in order to proceed with automatic payment and complete a checkout at the terminal.

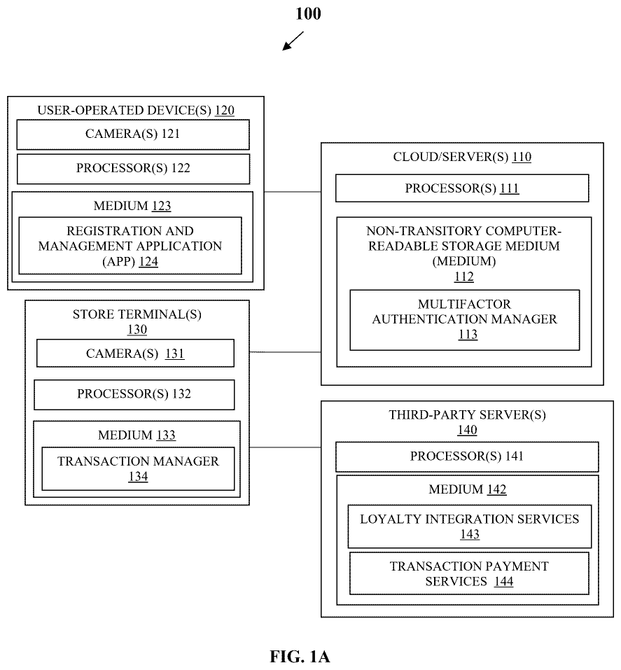

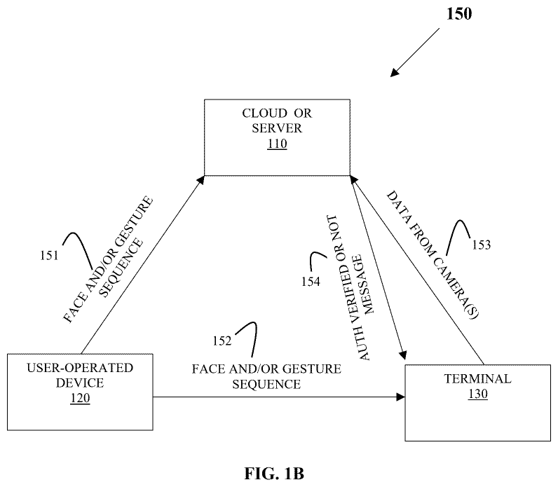

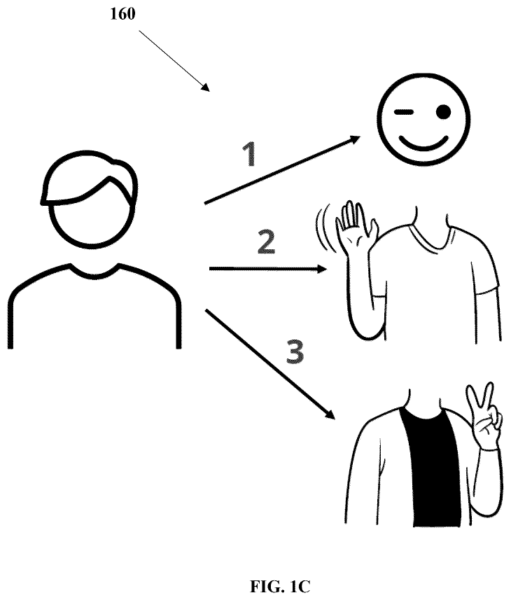

FIG. 1A is a diagram of a system 100 for enhanced biometric multifactor authentication for transactions, according to an example embodiment. Notably, the components are shown schematically in simplified form, with only those components relevant to understanding of the embodiments being illustrated.

Furthermore, the various components (that are identified in system 100) are illustrated and the arrangement of the components are presented for purposes of illustration only. Notably, other arrangements with more or less components are possible without departing from the teachings of AI and online shopping integration, presented herein and below.

System 100 includes a cloud/server 110 (hereinafter “cloud 110” of “cloud server 110”), one or more user-operated devices 120, one or more store terminals 130 (terminals 130), and one or more third-party servers 140. Cloud 110 includes at least one processor 111 and a non-transitory computer-readable storage medium (hereinafter “medium”) 112, which includes instructions for a multifactor authentication manager 113. The instructions when executed by processor 111 cause processor 111 to perform processing or operations discussed herein and below with respect to multifactor authentication manager 113.

Each user-operated device 120 includes one or more cameras 121, at least one processor 122, and a medium 123, which includes instructions for a registration and management application (“app”) 124. The instructions when executed by processor 122 cause processor 122 to perform processing and operations discussed herein and below with respect to registration and management app 124.

Each terminal 130 includes one or more cameras 131, at least one processor 132 and a medium 133, which includes instructions for a transaction manager 134. The instructions when provided to and executed by processor 132 cause processor 132 to perform the processing or operations discussed herein and below with respect to transaction manager 134.

Each third-party server 140 includes at least one processor 141 and a medium 142, which includes instructions for one or more loyalty integration services 143 and/or one or more transaction payment services 144. The instructions when provided to and executed by processor 141 cause processor 141 to perform the processing or operations discussed herein and below with respect to loyalty integration services 143 and/or transaction payment services 144.

Initially, a user registers for multifactor biometric authentication with multifactor authentication manager 113 via registration and management app 124 of a user-operated device 120. Registration and management app 124 provides a user interface (UI) for user interaction during a user's registration session or a user's management session with multifactor authentication manager 113.

During a user's registration session, the UI presents a variety of operations and selectable options to the user in order to receive a biometric facial signature for a face of the user and to receive at least two factors for the user's defined multifactor authentication. The two or more factors include one of: two or more facial expressions, two or more hand gestures, or one or more facial expressions and one or more hand gestures. The registration and management app 124 accesses a camera 121 integrated into or interfaced to user-operated device 120 for purposes of capturing at least one registration image depicting unique facial characteristics and measurements associated with or between the unique facial characteristics of the user's face. The unique characteristics and measurements represent the biometric facial signature for the user. Registration and management app 124 also uses additional images captured by the camera 121 depicting the user illustrating the multiple factors via facial expressions and/or hand gestures. The UI guides the user through the steps and properly focusing the camera 121 for purposes of providing and capturing quality registration images of the user's face, facial expressions, and hand gestures.

The facial expressions include by way of example only, a user's face with one eye open and one eye closed, with both eyes closed, lips sealed closely together, lips in a unique separated pose, one eyebrow or both eyebrows in a unique pose, lower jaw pushed to one side of the user's face, a head nod or nods, other known facial expressions (e.g., smiling, frowning, anger, surprise, etc.), and/or any combination of a pose associated with the users eyes, lips, eyebrows, and cheeks. The hand gestures include by way of example only, one or two of the user's hands with the fingers depicting a unique pose (e.g., a unique combination of fingers raised on one or two hands, an okay sign, one or more fingers of one or two hands making a pointing pose, a waving gesture with one or two hands, a peace sign made with one or two hands, waving one or more fingers of one or two hands back and forth, obscene hand gesture(s), finger pointing, with two fingers, index, or middle, etc.). Hand gesture(s) considered offensive or obscene can be defined per region and disallowed from being used for authentication.

In an embodiment, a single factor includes two or more of facial expressions and/or hand gestures. For example, a user can provide one factor in a captured image depicting the user simultaneously winking with a smile while holding up an okay sign with one hand, and the user can provide another factor in a captured image depicting the user simultaneously frowning with both eyes closed while holding up two clinched fists. Thus, a biometric factor defined by the user during the registration session includes a single facial expression and/or hand gesture or includes two or more facial expressions and/or hand gestures simultaneous performed by the user and depicted in the registration images.

In an embodiment, the user is permitted to explicitly define at least two factors that include any combination of facial expressions and/or hand gestures for the user's subsequent authentications during transactions at store terminals 130. Multifactor authentication manager 113 ensures during the subsequent transactions that each of the user's registered facial expressions and/or hand gestures are performed by the user in a correct sequence before multifactor authentication manager verifies and authenticates the user for the transactions. Thus, multifactor authentication manager 113 supports at least two or more factor-based user biometric authentication.

In an embodiment, a store or retailer associated with the store can prohibit obscene gestures from being registered as the user's authentication factors. In an embodiment, multifactor authentication manager 113 prohibits registration of obscene factures by a user based on a geographical location associated with a store since community standards and tolerances can vary based on the geographical location (e.g., by country some of which may have laws that prohibit obscene public gestures, by state within a country, by cultural or religious geographical locations, etc.).

In an embodiment, the UI of the registration and management app 124 provides through the UI other selectable options to the user with respect to the biometric multifactor authentication being registered by the user. For example, a setting or value provided by the user for one selectable option permits the user to define an interval of time during which the user must provide multiple factors before authentication of the user is to be denied. As another example, a setting or value provided by the user for another selectable option permits the user to indicate whether a specific sequence of the biometric multiple actors are required for user for purposes of authenticating the user.

During the registration session and after the user has supplied the user images and any settings or values for authentication, registration and management app 124 uses the facial image(s) to calculate the unique facial characteristics and corresponding measurements for purposes of generating data or a data structure representing the biometric facial signature of the user. Registration and management app 124 uses the images of the facial expressions, images of the hand gestures, and any settings or gestures for authentication to generate a hash value for each separate factor or to generate a single hash value for the multiple factors combined.

In an embodiment, the registration and management app 124 provides via the UI entry and selection fields for the user to register a payment method. Multifactor authentication manager 113 uses the registered payment method to provide payment information for the user during payment for subsequent user's transactions, which permits the user to have automatically captured images of their face and the registered multiple factors for authentication of automatic payment processing during checkouts for the subsequent transactions.

In an embodiment, the user is not permitted to indicate the sequence of the multiple factors are optional. That is, the user is required to provide a sequence dependent set of more than two factors during registration. In an embodiment, the user is permitted to user define a set of more than two factors that are to be authenticated independent of any sequence within a predefined period of time.

In an embodiment, the user is not permitted to define the time period during which the multiple factors have to be provided by the user during any subsequent user transactions used for authentication. In an embodiment the time period is set by the store, or a retailer associated with the store for all customers of the store or retailer.

In an embodiment and during the user session, the UI of registration and management app 124 provides options, entry fields, and/or options to use camera 121 for the user to register a payment method with multifactor authentication manager 113. In this embodiment, multifactor authentication manager 113 maintains the payment card details, payment service details, or bank information for user transaction payments in the record associated with the user.

Once the user is satisfied with multiple factors being registered and any settings or values for authentication, the UI requests that the user confirm registration. Once confirmed, registration and management app 124, sends the biometric facial signature and hash value(s) to multifactor authentication manager 113. The multifactor authentication manager 113 stores the user's biometric facial signature and corresponding hash value(s) in a record of a data store or in an entry in a table data structure. In an embodiment, the multifactor authentication manager 113 stores or indexes the record into the data store or the table data structures based on a hash value calculated from the user's biometric facial signatures.

During a management session of the user with multifactor authentication manager 113 via the UI of registration and management app 124, the user is permitted to review and change previously provided registration information. For example, the user can change one of the multiple factors, each of the multiple factors, modify the registered biometric facial signature, modify any previously set required time period during which the multiple factors must be performed by the user for successful authentication, and/or modify any setting or value previously set for the sequence of the multiple factors for successful authentication. During a management session, the user can suspend all subsequent multifactor biometric authentication and/or deregister with cloud 110 by deleting the user's biometric facial signature along with the hash or hashes associated with the user's previously registered multifactor sequence for the user supplied facial expressions and/or hand gestures.

After registration, embodiments of the invention proceed in any of the manners discussed herein. The user has also previously registered with at least one loyalty integration service 143 and/or transaction payment service 144 associated with one or more third-party servers 140. A registered user is physically present at a terminal 130 and is prepared to perform a checkout transaction at terminal 130. One or more cameras 131 of terminal 130 capture one or more images of the user's face.

In an embodiment, transaction manager 134 performs same biometric facial signature operations as what was described above for the registration and management app 124 in order to generate the user's biometric facial signature. Transaction manager 134 sends the user's biometric facial signature to a loyalty integration service 143 and loyalty integration service 143 returns a loyalty identifier associated with the user. Transaction manager 134 assigns transaction details for the transaction to a loyalty account of a store associated with the loyalty identifier and terminal 130.

In an embodiment, the transaction manager 134 sends the one or more images of the user's face to a loyalty integration service 143 and the loyalty integration service 143 performs its own biometric facial signature operations. Responsive to the image(s), loyalty integration service 143 sends back a loyalty identifier for the user. Transaction manager 134 assigns transaction details for the transaction to a loyalty account of a store associated with the loyalty identifier and terminal 130.

In an embodiment, a loyalty system associated with the store of the terminal 130 provides the loyalty integration service 143. In this embodiment, transaction manager 134 calculates the biometric facial signature for the image(s) depicting the user's face and sends the biometric facial signature to the loyalty system, which returns the loyalty identifier for the user back to transaction manager 134 for purposes of associating transaction details for the user's transaction with a registered user's loyalty account with the store.

Notably, in any of the above discussed embodiments, the user is assumed to have authorized use of the user's face for purposes of providing automated loyalty identification of the user. The user is also assumed to have authorized a registered payment method based on the user's face and/or based on the user's registered loyalty account for purposes of providing automated payment processing for user transactions.

Once the loyalty identifier that is linked to the user's loyalty account with the store is obtained, transaction manager 134 continues to process the user's items until the user selects via a transaction UI an option to proceed to checkout payment for the items. At this point, transaction manager 134 looks for and obtains images of the user from camera(s) 121. The images are streamed to multifactor authentication manager 113 and transaction manager 134 waits for an authorized or unauthorized reply message from the multifactor authentication manager 113.

Multifactor authentication manager 113 first calculates a biometric facial signature for the user and searches the registered data store or data structure for a corresponding registered user record having the user's previously registered multifactor authentication hash value(s) for the user defined facial expressions and/or hand gestures. When the multifactor authentication manager 113 finds no record for the user, multifactor authentication manager 113 sends an authentication failed message back to transaction manager 134. In this case, transaction manager 134 proceeds with the transaction UI to obtain a payment method from the user in order to perform payment processing for the user's transaction and complete checkout at the store.

When the multifactor authentication manager 113 finds a record based on the user's biometric facial signature, multifactor authentication manager 113 inspects the images being streamed and calculates hash values based on any identified facial expressions and/or hand gestures detected in the images within a predefined time period or predefined time frame. After the predefined time period, any images streamed by the transaction manager 134 to the multifactor authentication manager 113 are ignored. The calculated hash values are compared to the user's registered record. When none of the hash values are included in the user record, multifactor authentication manager 113 sends an authentication denied message back to transaction manager 134, which then proceeds with the transaction UI to obtain a payment method from the user in order to perform payment processing for the user's transaction and complete checkout at the store.

When the multifactor authentication manager 113 matches each of the user's registered multiple factors, via the calculated hash values from the images to a single hash value representing each of factors and/or to separate hash values for each factor, multifactor, to the calculated candidate hash value(s), multifactor authentication manager 113 sends an authentication succeeded message back to transaction manager 134. Transaction manager 134 proceeds with payment using a loyalty integration service 143 for which the user has a registered payment method with; proceeds with payment using a transaction payment service 144 for which the user has registered a payment method; proceeds with payment based on a registered payment of the user with multifactor authentication manager 113; or proceeds with payment using a loyalty system of the store for which the user has a registered payment method.

In an embodiment and in real time, as the multifactor authentication manager 113 authenticates each registered biometric factor for the user from the images, multifactor authentication manager 113 sends a factor authenticated message to transaction manager along with the image corresponding to the user performing a corresponding facial expression and/or hand gesture. Responsive to the factor authenticated message, transaction manager 134 instructs the transaction UI to present the image along with a visual indication, such as a big green checkmark, superimposed over the image as real-time feedback to the user. Further, assuming a user does not perform a correct facial expression and/or hand gesture or performs a facial expression and/or hand gesture in an incorrect sequence, multifactor authentication manager 113 sends a factor incorrect message to transaction manager 134 causing the transaction UI to present the corresponding image along with a visual indication, such as a big red X, superimposed over the image as real-time feedback to the user.

In an embodiment and when user authentication fails during a transaction, transaction manager 134 instructs the transaction UI to present an authentication failed screen with options for the user to retry or proceed to payment without auto biometric multifactor authentication. In an embodiment, a store or a retailer associated with the transaction sets a predefined number of retries that the user is permitted to make. When the number of retries fails to authenticate the user, transaction manager 134 instructs the transaction UI to present payment method input screens to the user for receiving the user's payment method in order to process payment and complete checkout of the transaction.

When transaction manager 134 receives an authentication success message from multifactor authentication manager 113, transaction manager 134 automatically proceeds with a configured transaction payment service 144 or with a configured loyalty integration service 143 to process a user payment for a given transaction. When the payment service 144 is used, the transaction manager 134 uses the user's registered payment details provided by multifactor authentication manager 113 with the authentication success message. When the loyalty integration service 143 is used, the transaction manager 134 relies on the loyalty integration service 143 to complete the payment processing. The loyalty integration service 143 uses its own transaction payment service to complete the payment.

In an embodiment and when the transaction manager 134 receives an authentication success message from multifactor authentication manager 113, transaction manager 134 receives the payment details back from the multifactor authentication manager 113 and performs payment processing for the transaction using a configured transaction payment service 144. Here, the user registered the payment method during the user's registration session with multifactor authentication manager 113 via the UI of the registration and management app 124.

In an embodiment, and when the transaction manager 134 receives an authentication success message from multifactor authentication manager 113, the transaction manager 134 uses a store or retailer loyalty system to retrieve payment details registered to the user's loyalty account. Transaction manager 134 then performs automatic payment process with a configured transaction payment service 144 using the payment details.

In an embodiment and during a registration session between the user and the multifactor authentication manager 113, the UI of the registration and management app 124 permits the user to indicate at least one biometric-based facial expression and/or hand gesture required before transaction manager 134 is permitted to proceed with a user's transaction linked to the user's loyalty account. This is an additional biometric authentication defined by the user for using and linking the user's loyalty account with the store and/or retailer for the transaction details. The user still has to separately define the multiple factors for automatic payment processing during transactions of the user. This provides enhanced biometric authentication for user loyalty identification, which is particularly beneficial to users who have positive and redeemable loyalty rewards or points that can be applied as all of, or a portion of payment totals required for user transactions. In this embodiment, multifactor authentication manager 113 authenticates a user's facial signature and the facial expression and/or hand gesture factor and returns a loyalty confirmed or authenticated message back to transaction manager 134. If multifactor authentication manager 113 is unable to authenticate both the user's biometric facial signature and the biometric factor, multifactor authentication manager 113 sends a loyalty not verified message back to transaction manager 134. Transaction manager 134, in response to the message, instructs transaction UI to display a popup window within the UI informing the user that loyalty was unable to be authenticated and asking the user if the user wishes to proceed with the transaction without a loyalty identifier or whether the user wishes to provide loyalty information directly for the transaction. Note that this feature can be used even when transaction manager 134 uses a loyalty integration service 143 for providing the user's loyalty identifier if desired by the user for added facial-based loyalty identification.

In an embodiment, camera 131 is an existing and unmodified depth and red-green-blue (RGB) camera, which provides depth values for pixels of images captured and RGB values for the pixels. In an embodiment, camera 131 is an existing and unmodified RGB camera that just provides RGB values for the pixels of the images. In an embodiment, terminals 130 include self-service terminals, point-of-sale terminals, automated teller machines, and/or kiosks.

System 100 permits users, stores, and retailers to enhance and extend biometric authentication providing improved security and accuracy to biometric authentication approaches. This is achieved without modifying existing services, such as loyalty integration services 143, which use a conventional biometric user authentication, and which are already integrated into a transaction workflow for user transactions. The user defines and customizes the additional biometric factors that are to be used for the extended multifactor authentication. During a transaction, the user's additional biometric factors are verified from transaction images depicting the user performing one or more of facial expressions and/or hand gestures. Upon verification and successful authentication, the user's checkout for the transaction is expedited by performing automatic payment processing on behalf of the user in the background seamless and transparent to the user who is interacting with a transaction UI of a terminal 130.

Furthermore, because the user does not have to manually insert a payment card into a card reader of terminal 130 or manually enter payment details into a transaction UI screen for transaction payment, system 100 also prevents known fraudulent techniques (e.g., card skimmers, card shimmers, software-based phishing, card trappers, malware, etc.) from acquiring the user's payment details. Thus, system 100 not only enhances security with respect to existing biometric authentication but also enhances security with respect to existing card stealing approaches.

System 100 also mitigates financial exposure of stores and retailers by providing an additional layer of security through the enhanced biometric authentication for their transactions. That is, financial institutions charge back retailers when a transaction is fraudulent such that the financial losses of fraud during payment is bore by the retailers. System 100 provides security mechanism by which the retailers and stores can mitigate fraudulent transactions independently of the corresponding financial institutions and this security mechanism is enforced before a user's card details are sent to a transaction payment service 144 for payment processing.

System 100 further increases customer satisfaction by providing control of a user's biometric authentication to the user and by alleviating false biometric authentication for the user via the disclosed biometric multifactor authentication. Conventional biometric face authentication is prone to misidentifications and is dependent on the quality of the image captured by a given camera. The addition of multiple factors based on user-defined and performed facial expressions and/or hand gestures, described herein, means that the quality of the image required can be lowered from conventional approaches while at the same time achieving stronger accuracy over the conventional approaches. In addition, system 100 permits a user to have automatic payments performed for a transaction without the user having to insert any payment card, without the user having to enter payment details through a transaction UI screen, a without the user having to be in possession of their phone. Thus, if the user forgot a phone that includes a wireless payment method for use at a terminal 130, the user can still have automatic payments performed using the techniques described herein.

Still further, system 100 does not store images of the user performing the facial expressions and/or hand gestures and does not store any image of the user at all. Only the user's biometric facial signature and a hash or hashes of the user's facial expressions and/or hand gestures are stored. This ensures privacy and security with respect to the user's biometric data. Moreover, at any point in time the user can establish a management session to delete the user's biometric facial signature and/or hash or hashes on images of the user performing the facial expressions and/or hand gestures. Thus, what system 100 does not include any images of the user and the user retains control which provides security and enhanced privacy protection to the user.

FIG. 1B is a diagram of illustrating a data flow 150 associated with the system of FIG. 1A, according to an example embodiment. A user establishes a registration session with multifactor authentication manager 113 via registration and management app 124 of a user-operated device 120. At 151, the user provides images depicting the user performing multiple facial expressions and/or hand gestures defined in a sequence with which they are to be performed during the user's registration session. Multifactor authentication manager 113 of cloud 110 generates and maintains a registration record for the user indexed on the user's biometric facial signature and including one or more hash values representing a hash on the multiple factors. Subsequent, the user is detected at a terminal 130 for a transaction with a store. Transaction manager 134 of terminal 130 generates a candidate biometric facial signature from one or more images depicting the user's face and captured by one or more cameras integrated into or interfaced with terminal 130.

Transaction manager 134 provides the candidate biometric facial signature to a loyalty integration service 143, which returns a loyalty identifier for the user with the store based on the candidate biometric signature. Transaction manager 134 links the transaction details for the transaction to a loyalty account of the user with the store based on the loyalty identifier. When the user selects a checkout option or payment option, the transaction UI presents an option for the user to pay via facial recognition for example a “face pay option.” When the user selects the option from the transaction UI and at 152, camera 131 provides images depicting the user to transaction manager 134. The images depicting the user's face and the user performing the facial expressions and/or hand gestures. Optionally, transaction manager 134 calculates a biometric facial signatures from an image of the user's face.

At 153, transaction manager 134 streams the images of the user and corresponding data associated with the images to multifactor authentication manager 113 on cloud 110. Optionally, transaction manager 134 also provides a candidate biometric signature with the images and camera data to multifactor authentication manager 113.

Multifactor authentication manager 113 generates a biometric facial signature on a face of the user depicted in the images. Optionally, the biometric facial signature is received from transaction manager 134. The multifactor authentication manager 113 uses the biometric facial signature to determine whether a registered user record is present in a registration data store or a registration data structure of cloud 110. Assuming a record is found, multifactor authentication manager 113 generates one or more hash values from the images for facial expressions and hand gestures detected. At 154, the multifactor authentication manager 113 compares the candidate hash value(s) against the hash value(s) stored in the registration record; multifactor authentication manager 113 sends an authentication successful message back to transaction manager 134 when a match is detected or multifactor authentication manager 113 sends an authentication not successful or failed message back to transaction manager 134 when no match is detected.

Assuming transaction manager 134 receives an authentication successful message, transaction manager 134 obtains the user's payment card details for processing payment and sends the transaction details and payment card details to a transaction payment service 144. Alternatively, the transaction manager 134 sends the transaction details and the user's biometric facial signature to a loyalty integration service 143 or a transaction payment service 144 for payment processing. Payment processing can also proceed in any of the other manners discussed above.

FIG. 1C is a pictorial diagram depicting example user interactions 160 for enhanced biometric multifactor authentication during a transaction at a terminal, according to an example embodiment. When the user initiates a pay with face option of the transaction UI of transaction manager 134 on a terminal 130, The user performs the user-defined facial expressions and/or hand gestures in front of camera 131. In the example illustrated, the user has previously registered three biometric factors. Factor 1 illustrates the user performing a single factor through a combination of different facial expressions by closing one eye and smiling. Factor 2 illustrates the user with a raised hand waving. Factor 3 illustrates the user with a lefthand raised depicting a peace sign. The sequence of the factors were defined by the user during the registration session.

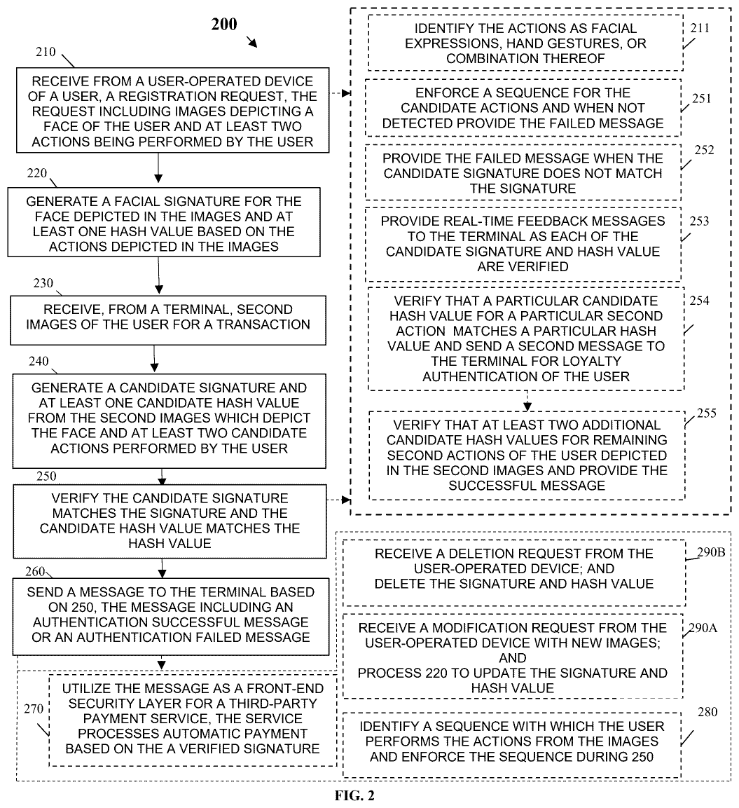

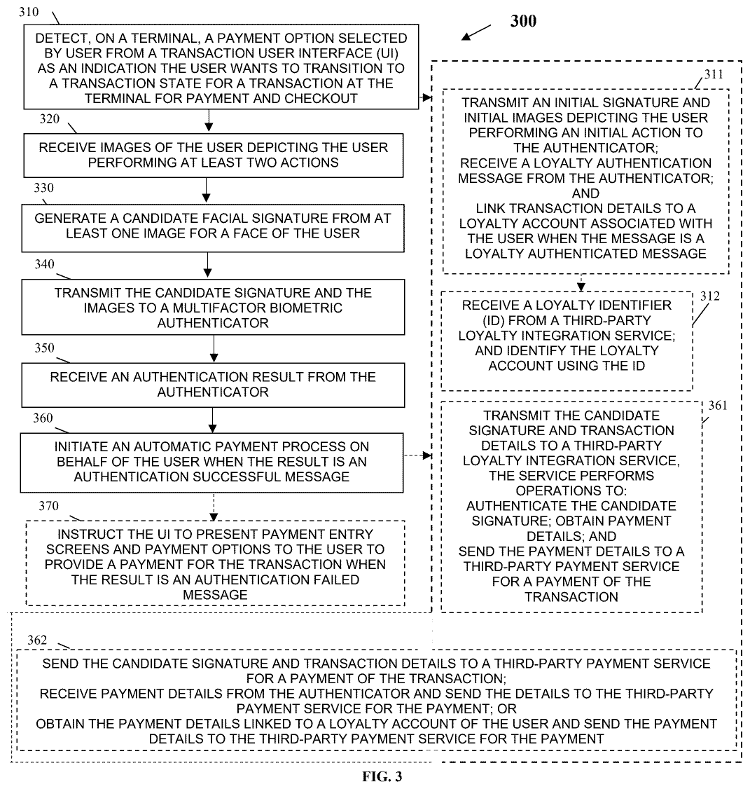

The above-referenced embodiments and other embodiments are now discussed with reference to FIGS. 2 and 3. FIG. 2 is a flow diagram of a method 200 for enhanced biometric multifactor authentication for a transaction, according to an example embodiment. The software module(s) that implements the method 200 is referred to as an “multifactor authentication manager.” The multifactor authentication manager is implemented as executable instructions programmed and residing within memory and/or a non-transitory computer-readable (processor-readable) storage medium and executed by one or more processors of one or more devices. The processor(s) of the device(s) that executes the multifactor authentication manager are specifically configured and programmed to process the multifactor authentication manager. The multifactor authentication manager may have access to one or more network connections during its processing. The network connections can be wired, wireless, or a combination of wired and wireless.

In an embodiment, the device that executes the multifactor authentication manager is cloud 110. In an embodiment, the device that executes the AI virtual shopping assistant is a retail server. In an embodiment, the AI virtual shopping assistant is multifactor authentication manager 113.

At 210, AI virtual shopping assistant receives, from a user-operated device 120 operated by a user, a registration request. The request includes images depicting a face of the user and at least two actions being performed by the user. In an embodiment, the user establishes via a registration and management app 124 a registration session with the method for purposes of registering the user's face and the actions as biometric data depicted in images captured by a camera 121 of the user-operated device 120.

In an embodiment, at 211, the AI virtual shopping assistant identifies the actions as facial expressions, hand gestures, or any combination thereof. In an embodiment, a single action is identified as a combination of both a facial expression and a hand gesture.

At 220, the AI virtual shopping assistant generates a facial signature (i.e., a biometric facial signature) for the face of the user depicted in the images. The AI virtual shopping assistant also generates at least one hash value based on the actions as a whole or based on each individual action.

At 230, the AI virtual shopping assistant receives, from a terminal 130, second images of the user for a transaction. The user is initiating a transaction on the terminal 130 and a camera 131 of terminal 130 provides the images, which the terminal 130 streams to the AI virtual shopping assistant.

At 240, the AI virtual shopping assistant generates a candidate facial signature and at least one candidate hash value from the second images. The second images depict the face of the user and at least two candidate actions performed by the user.

At 250, the AI virtual shopping assistant verifies that the candidate facial signature matches the user's registered facial signature. The AI virtual shopping assistant also verifies that candidate hash value(s) match the registration generated hash value(s).

In an embodiment, at 251, the AI virtual shopping assistant enforces a sequence for the candidate actions. That is, the actions performed by the user and depicted in the second images are performed in a candidate sequence which has to match the registration sequence for which the user performed the registration actions depicted in the registration images. In an embodiment, the generated candidate hash value(s) from 250 account for the enforced sequence as does the generated registration hash value(s) from 220. When AI virtual shopping assistant determines that the sequence is not represented in the second images, the AI virtual shopping assistant provides the authentication failed message to 260.

In an embodiment, at 252, the AI virtual shopping assistant provides the authentication failed message when the candidate facial signature does not match the registration facial signature. That is, the AI virtual shopping assistant checks to ensure that the AI virtual shopping assistant actually has a registration record for the user based on finding a registration record or not finding a registration record using the candidate facial signature to search a data store or a data structure.

In an embodiment, at 253, the AI virtual shopping assistant provides real-time feedback messages to the terminal 130 as the AI virtual shopping assistant verifies each of the candidate facial signature and each of the candidate hash values. The real-time feedback messages cause terminal 130 to present a corresponding second image within the transaction UI with a visual indication representing a corresponding real-time feedback message. For example, a large red X is presented to the user within the transaction UI when verification fails when facial recognition or one or more the second actions fail verification based on corresponding real-time messages. As another example, a large green checkmark is presented to the user within the transaction UI when verification is successful when facial recognition or one or more of the second actions pass verification.

In an embodiment, at 254, the AI virtual shopping assistant verifies that at particular candidate hash value for a particular second action matches a particular registration hash value. This is a situation where the user desires loyalty authentication for use of the user's loyalty account and during the registration session provided a user performed action for this additional biometric authentication. The AI virtual shopping assistant sends a second message to the terminal 130 indicating that loyalty biometric authentication passed or was successful with a loyalty authentication successful message. The AI virtual shopping assistant sends a second message to the terminal to the terminal 130 indicating that loyalty biometric authentication failed or was unsuccessful with a loyalty authentication failed message.

In an embodiment of 254 and at 255, the AI virtual shopping assistant verifies that at least two additional candidate hash values for remaining second action of the user depicted in the second images matches at least one remaining hash value. This accounts for a situation as discussed in 254, where a registered biometric user action depicted in the registration images was used for loyalty account authentication. Notably, the hand gesture action or facial expression action registered by the user for biometric loyalty authentication can also be used by the user with the multiple factor authentication by the user; alternatively, the user can register a hand gesture action, a facial expression action, or a combination thereof combination expression and gesture for biometric loyalty authentication which is not depicted in the actions registered by the user for multiple factor biometric authentication. When the AI virtual shopping assistant verifies that at least two additional candidate hash values match the remaining hash value(s), AI virtual shopping assistant provides an authentication successful message to 260.

At 260, the AI virtual shopping assistant sends a message to terminal 130 based on 250. The message includes an authentication successful message or an authentication failed message.

In an embodiment, at 270, the AI virtual shopping assistant is processed on a cloud server 110 as front-end security layer for a third-party payment service 144. The third-party payment service 144 performs of processes an automatic payment on behalf of the user at the terminal for the transaction based on a verified signature and verified second actions. The AI virtual shopping assistant provides an additional biometric multiple factor authentication in a manner that is completely transparent to the third-party payment service 144, which provided automatic payment processing based on biometric facial authentication.

In an embodiment, at 280, the AI virtual shopping assistant identifies a sequence with which the user performs the registered two actions depicted in the registered images obtained at 210. The AI virtual shopping assistant enforces the sequence during processing of 250.

In an embodiment, at 290A, the AI virtual shopping assistant receives a modification request from the user during a management session with the AI virtual shopping assistant. The modification request includes additional images depicting the face of the user and depicting the user performing at least two additional actions in a different sequence or showing different actions from what the user initially registered during a registration session with the AI virtual shopping assistant. The AI virtual shopping assistant processes 220 and 240 to update the registered facial signature and/or update the hash value(s). This provides control to the user should the user believe that their registered facial signature, their facial expressions and/or hand gestures, or their sequence of facial expressions and/or hand gestures are compromised or require strengthen.

In an embodiment, at 290B, the AI virtual shopping assistant receives a deletion request from the user-operated device 120 of the user during a management session with AI virtual shopping assistant. In response to the deletion request, AI virtual shopping assistant deletes the user's registered record from the data store or the data structure. This provides control to the user should the user desire more privacy and not even want a facial signature registered or used. The user remains in control with respect to the degree with which the user wants to protect their privacy at all times.

FIG. 3 is a diagram of another method 300 for enhanced biometric multifactor authentication for a transaction, according to an example embodiment. The software module(s) that implements the method 300 is referred to as a “transaction manager.” The transaction manager is implemented as executable instructions programmed and residing within memory and/or a non-transitory computer-readable (processor-readable) storage medium and executed by one or more processors of one or more device(s). The processors that execute the transaction manager are specifically configured and programmed for processing the transaction manager. The transaction manager may have access to one or more network connections during its processing. The network connections can be wired, wireless, or a combination of wired and wireless.

In an embodiment, the device that executes online transaction manager is terminal 130. In an embodiment, terminal is a self-service terminal, a point-of-sale terminal, an automated teller machine, or a kiosk. In an embodiment, the transaction manager is transaction manager 134. The transaction manager interacts with method 200 of FIG. 2.

At 310, the transaction manager detects, on a terminal 130, a payment option selected by the user from a transaction UI as an indication the user wants to transition to a transaction state for a transaction at the terminal 130 for payment and checkout. The payment option is an enhanced transaction UI option associated with automatic payment based on user biometrics. As an example, the payment option is a selectable button labeled as “Face Payment.” In an embodiment, after selecting the Face Payment UI option, a second authorization screen, along with an appropriate legal disclosure, is presented such that before proceeding with the multiple factor biometric authentication features of the transaction manager, the user must affirmative provide authorization.

In an embodiment, at 311, the transaction manager transmits an initial signature and initial images depicting the user performing an initial action to a multifactor authentication manager (e.g., multifactor authentication manager 113 and/or method 200). The transaction manager receives a loyalty authentication message back from the multifactor authentication manager and the transaction manager links transaction details for the transaction to a loyalty account of the user when the loyalty authentication message is a loyalty authenticated message. When the loyalty authentication message is a loyalty authentication failed message, transaction manager delinks any previously linked user loyalty account from being associated with the transaction.

In an embodiment of 311 and at 312, the transaction manager receives a loyalty identifier from a third-party loyalty integration service 143. The transaction manager receives the loyalty identifier based on a biometric facial signature for a face of the user provided as input to the third-party loyalty integration service 143. The transaction manager identifies the loyalty account from a loyalty system using the provided loyalty identifier.

At 320, the transaction manager receives images of the user provided by one or more cameras 131 or image sensors integrated into or interfaced to terminal 130. The images depict the face of the user and the user performing at least two actions.

At 330, the transaction manager generates a candidate facial signature from at least one of the images for the face of the user. At 340, the transaction manager transmits or sends the candidate signature and the images to a multifactor biometric authenticator (e.g., multifactor authentication manager 113 and/or method 200).

At 350, the transaction manager receives an authentication result from the multifactor biometric authenticator. The authentication result includes either an authentication successful message or an authentication failed message.

At 360, the transaction manager initiates an automatic payment process on behalf of the user when the authentication result is the authentication successful message.

In an embodiment, at 361, the transaction manager transmits the candidate signature and transaction details for the transaction to a third-party loyalty integration service 143. The third-party loyalty integration performs the payment process by authenticating the candidate signature to the user, obtaining a registered payment method for the user, obtaining registered payment details from the registered payment method, and sending the registered payment details to a third-party payment service 144 for a payment of the transaction.

In an embodiment, at 362, the transaction manager performs any one of the following. The first option includes the transaction manager sending the candidate signature and transaction details to a third-party payment service 144 for payment of the transaction. The second option includes the transaction manager receiving the payment details from the multifactor biometric authenticator and sending the payment details to the third-party payment service 144 for the payment of the transaction. The third option includes the transaction manager obtaining the payment details linked to a loyalty account of the user and sending the payment details to the third-party payment service 144 for the payment of the transaction.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, from a user-operated device of a user, a registration request, wherein the registration request including images depicting a face of the user and at least two actions being performed by the user;
generating a facial signature for the face depicted in the images and at least one hash value based on the at least two actions depicted in the images;
receiving, from a terminal, second images of the user for a transaction;
generating a candidate facial signature and at least one candidate hash value from the second images which depict the face and at least two candidate actions performed by the user;
verifying the candidate facial signature matches the facial signature and the at least one candidate hash value matches the at least one hash value; and
sending a message to the terminal based on the verifying, wherein the message including an authentication successful message or an authentication failed message.

2. The method of claim 1, further comprising utilizing the message as a front-end security layer for a third-party payment service, wherein the third-party payment service performs automatic payment transaction based on a verified facial signature of the user.

3. The method of claim 1, further comprising identifying a sequence with which the user performs the at least two actions from the images and enforcing the sequence during the verifying.

4. The method of claim 1, further comprising:
receiving a modification request from the user-operated device comprising additional images depicting the user performing the at least two actions in a different sequence or performing different actions; and
processing the generating of the facial signature and the at least one hash value to update one or more of the facial signature and the at least one hash value.

5. The method of claim 1, further comprising:
receiving a deletion request from the user-operated device; and
deleting the facial signature and the at least one hash value to deregister the user from multiple factor biometric authentication services provided by the method.

6. The method of claim 1, wherein receiving the registration request further includes identifying the at least two actions depicted in the images as facial expressions, user hand gestures, or a combination thereof.

7. The method of claim 1, wherein verifying further includes enforcing a time frame within which the at least one candidate hash value has to be matched to the at least one hash value and if not matched providing the authentication failed message to the sending.

8. The method of claim 1, wherein verifying further includes enforcing a sequence associated with the at least two candidate actions depicted in the second images and when the sequence is not detected providing the authentication failed message to the sending.

9. The method of claim 1, wherein verifying further includes providing an authentication failed message to the sending when candidate facial signature does not match the facial signature.

10. The method of claim 1, wherein verifying further includes providing real-time feedback messages to the terminal as each of the candidate facial signature and the at least one hash value are successfully or unsuccessfully matched.

11. The method of claim 1, wherein verifying further includes verifying that a particular candidate hash value for a particular second action of the user depicted in the second images matches a particular hash value and sending a second message to the terminal, wherein the second message including a loyalty authentication successful message or a loyalty authentication failed message.

12. The method of claim 11, wherein verifying further includes verifying that at least two additional candidate hash values for remaining second actions of the user depicted in the second images matches at least one remaining hash value and providing the authentication successful message or the authentication failed message to the sending.

13. A method, comprising:
detecting, on a terminal, a payment option selected by a user from a transaction user interface indicating the user wants to transition to a transaction state for a transaction at the terminal for payment and checkout;
receiving images of the user depicting the user performing at least two actions;
generating a candidate facial signature from at least one of the images for a face of the user, wherein the images depict the face and the user performing at least two actions;
transmitting the candidate facial signature and the images to a multifactor biometric authenticator;
receiving an authentication result from the multifactor authenticator; and
initiating an automatic payment process on behalf of the user when the authentication result is an authentication successful message.

14. The method of claim 13, further comprising instructing the transaction user interface to present payment entry screens and payment options to the user to provide a payment for the transaction when the authentication result is an authentication failed message.

15. The method of claim 13, wherein detecting further includes:
transmitting an initial candidate facial signature and initial images depicting the user performing an initial action to the multifactor biometric authenticator;
receiving a loyalty authentication message back from the multifactor biometric authenticator; and
linking transaction details for the transaction to a loyalty account associated with the user when the loyalty authentication message is a loyalty authenticated message.

16. The method of claim 15, wherein linking further includes:
receiving a loyalty identifier from a third-party loyalty integration service based on providing the initial facial signature to the third-party loyalty integration service; and
identifying the loyalty account using the loyalty identifier.

17. The method of claim 13, wherein initiating further includes:
transmitting the candidate facial signature and transaction details to a third-party loyalty integration service, wherein the third-party loyalty integration service performs operations comprising:
authenticating the candidate facial signature;
obtaining registered payment details for the user based on the authenticating; and
sending the registered payment details to a third-party payment service for a payment of the transaction at the terminal based on the authenticating.

18. The method of claim 13, wherein initiating further includes one of:
sending the candidate facial signature and transaction details for the transaction to a third-party payment service for a payment of the transaction;
receiving payment details for the user from the multifactor biometric authenticator and sending the payment details to the third-party payment service for the payment; or
obtaining the payment details linked to a loyalty account of the user and send the payment details to the third-party payment service for the payment.

19. A system, comprising:
a terminal comprising at least one processor and a non-transitory computer-readable storage medium having stored instructions which, when executed by the at least one processor, cause the processor to:
detect a payment option selection from a user during a transaction at the terminal;
receive images of the user performing actions during the transaction;
generate a candidate facial signature from at least one of the images depicting a face of the user;
transmit the candidate facial signature and the images to a cloud server;
receive an authentication result from the cloud server; and
initiate a payment process based on the authentication result; and
the cloud server comprising at least one process and a non-transitory computer-readable storage medium having stored instructions which, when executed by the at least one processor, cause the processor to:
receive a registered candidate facial signature and registration images depicting the actions during a registration session with the user;
receive the candidate facial image and the images depicting the actions from the terminal;
verify the candidate facial signature against the registered candidate facial signature;
generate at least one candidate hash value from the images;
compare the at least one candidate hash value against at least one registered hash value obtained from the registration images during the registration session; and
send an authentication result to the terminal based on verifying the candidate facial signature against the registered facial signature, comparing the candidate facial signature against the registered facial signature, and comparing the at least one candidate hash value to the at least one registered hash value.

20. The system of claim 19, wherein the at least one processor of the terminal is further configured to:
interact with a third-party loyalty integration service to obtain an initial loyalty identifier based on the candidate facial signature;
associate transaction details for the transaction with a loyalty account linked to the loyalty identifier; and
process payment for the transaction using registered payment details associated with the loyalty account when the authentication result is an authentication successful message.
